(19) United States
(12) Patent Application Publication
(10) Pub. No.: US 2010/0007257 A1
(43) Pub. Date: Jan. 14, 2010

(54) Spark Plug

(76) Inventors: Thomas Kaiser, Stuttgart (DE); Dirk Scholz, Stuttgart (DE); Simon Schmittinger, Renningen (DE); Jochen Fischer, Bamberg (DE)

Correspondence Address: KENYON & KENYON LLP, ONE BROADWAY, NEW YORK, NY, 10004, US

(21) Appl. No.: 11/992,107

(22) PCT Filed: Aug. 18, 2006
(86) PCT No.: PCT/EP2006/065444

§ 371 Date: Sep. 3, 2009

(30) Foreign Application Priority Data
Sep. 16, 2005 (JP) 102005044267.6

(51) Int. Cl. H01T 13/16

(52) U.S. Cl. 313/11.5

(57) ABSTRACT

A spark plug for an internal combustion engine has a housing and an insulator held in a clamping area of the housing, which electrically insulates a central electrode from the housing, a heat transfer area having a circumferential gap between the housing and the insulator being provided in the area of a combustion chamber-side end section of the housing for dissipating the heat absorbed by the insulator. The heat transfer area and the clamping area are spatially separated from each other.

### FIELD OF THE INVENTION

The present invention relates to a spark plug for an internal combustion engine.

### BACKGROUND INFORMATION

A spark plug for igniting a fuel mixture in a cylinder of an internal combustion engine is described, for example, in European Patent Application No. EP 0 480 670.

The available space for installing such spark plugs in a vehicle is becoming increasingly scarcer. One reason for this is that in today's engines, a plurality of intake valves, for example, four or five valves per cylinder, are provided to achieve improved cylinder charging and thus more power, in particular more torque even at low rotational speeds and over a large rotational speed range, and thus a fuel-saving mode of operation. Multiple valves of this type considerably limit the space available for the installation of an injector.

Higher power per unit displacement also requires larger cooling channels, which require additional installation space. In addition, in internal combustion engines having direct injection, further space is required for installing the high-pressure injector.

In order to provide this additional installation space, spark plugs having smaller and smaller diameters are required. In addition, spark plugs having a longer shape are preferred because a larger length of the spark plug housing creates space for the larger cooling channels.

Furthermore, it must be taken into account that, in addition to the increased electrical field intensity in the insulator of a spark plug due to the reduced spark plug diameter, the field intensity also increases due to an increase in the ignition voltage. The increase in the ignition voltage is due to the increased compression of internal combustion engines, in particular of direct injection engines and by the supercharging of the engines. In addition, at specific operating points, for example, while heating the catalytic converter or in traction control, particularly high ignition voltage is achieved due to the retarded ignition angle, which is to be taken into account when designing a spark plug.

An object of the present invention is to provide a spark plug having a maximally slim shape in view of the above-named requirements.

### SUMMARY OF THE INVENTION

According to the present invention, a spark plug for an internal combustion engine is provided which has a housing and an insulator held in a clamping area of the housing, which electrically insulates a central electrode from the housing, a heat transfer area having a circumferential gap between the housing and the insulator being provided in the area of a combustion chamber-side end section of the housing for dissipating the heat absorbed by the insulator, and the heat transfer area and the clamping area being separated from one another.

Due to spatial separation between the heat transfer area and the clamping area, a spark plug design making possible a reduction in the housing diameter and a longer, slimmer shape of the spark plug is advantageously implemented.

The separation of the clamping area, i.e., the longitudinal section of the spark plug used for absorbing a clamping force of the insulator, from the heat transfer area makes it possible to dimension the housing of the spark plug smaller, in particular in the area of the heat transfer area, because a housing shoulder provided in known spark plugs as a support is not needed for the insulator in this area.

In this way, on the one hand, relatively small thread diameters of M10,for example, or smaller may be implemented on the housing for screwing in the spark plug into a cylinder head housing and, on the other hand, thicker insulator walls are made possible in this area without increasing the dimensions of the housing in this area. Due to the increased wall thickness of the insulator, the spark plug is suitable for use in cylinder heads having larger cooling channels and high ignition voltages required by the engine because the likelihood of electrical breakthroughs in the case of thicker ceramic walls is minimal even at higher ignition voltages.

In an advantageous refinement of the present invention, the clamping area is situated between an axially central section and an end of the housing facing away from the combustion chamber. The insulator may thus be supported in the housing at the level of a tool grip face of the housing shaft, normally designed as a circumferential polygonal surface, approximately in a central area of the spark plug, so that a slim shape may be implemented.

Most of the heat transfer from the insulator to the housing may take place by direct component contact in the area of the insulator foot base as it does also in the case of the known designs.

In an advantageous embodiment, the clamping area of the housing surrounds a longitudinal section of the insulator delimited by support shoulders, which is situated approximately in the central area of the elongated insulator; the housing may axially surround a corresponding longitudinal section of the insulator by a crimped border of the housing and by a housing shoulder for clamping the insulator and may be shrunk onto this section of the insulator.

Due to the displacement of the combustion chamber-side support surface of the insulator on the housing into the central area of the spark plug, i.e., the area of the tool grip surface on the housing shaft, the additional advantage results that the clamping length between the crimped border and the housing shoulder may be selected to be very short. The problem of insufficient thermal insulation, which is to be taken into account in known elongated spark plugs, may thus be avoided.

In order to seal the gap between the housing and the insulator, according to an advantageous embodiment of the present invention it may be provided that the housing shoulder is designed in the clamping area as a seal seat having a sealing ring for sealing the gap on the combustion chamber side. In this way it is ensured, also in the spark plug according to the present invention, that no gas is able to escape from the combustion chamber into the environment through the gap.

In the spark plug according to the present invention, the heat transfer from the insulator to the housing may be advantageously configured by placing at least one element in the gap between the insulator and the housing to improve the heat transfer. For example, a spring element, a ring, a hollow section, a coiled wire, or also a sleeve made of a heat-conducting material may be used as such an element.

This listing of elements to improve the heat transfer is only exemplary and not exhaustive, so that other design forms of the element may also be conceivable. It is also conceivable that multiple elements may be used in the gap between the housing and the insulator for better dissipation of heat from the insulator into the housing in order to thus reduce thermal stress.

Copper, for example, may be used as a heat-conducting material.

The contact between insulator and housing may also be implemented by using a permanently elastic element such as, for example, a copper paste or the like.

### BRIEF DESCRIPTION OF THE DRAWINGS

FIG. 1 shows a simplified partially sectioned view of a spark plug.

FIG. 2 shows a detailed view of an area A according to FIG. 1 having an element designed as a ring for improving the heat transfer.

FIG. 3 shows a first embodiment variant of area A of FIG. 1 having an element designed as a spring element for improving the heat transfer.

FIG. 4 shows a second embodiment variant of area A of FIG. 1 having an element designed as a hollow section for improving the heat transfer.

FIG. 5 shows a third embodiment variant of area A of FIG. 1 having an element designed as a coiled wire for improving the heat transfer.

FIG. 6 shows a fourth embodiment variant of area A of FIG. 1 having an element designed as a sleeve for improving the heat transfer.

### DETAILED DESCRIPTION

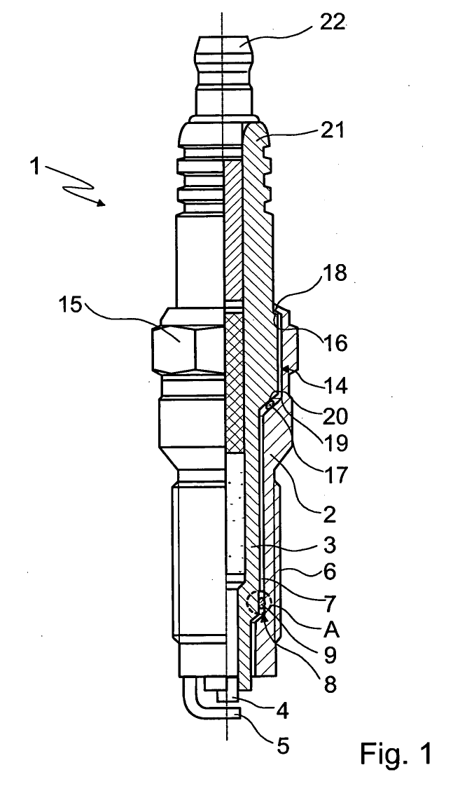

FIG. 1 shows a partially sectioned overall view of a possible specific embodiment of a spark plug 1 designed according to the present invention.

Spark plug 1 has an elongated metallic housing 2 having an axial bore hole which holds an insulator 3. Insulator 3 made of a ceramic material in turn has a stepped longitudinal bore hole in which a central electrode 4 is situated, which is electrically insulated against housing 2 by insulator 3.

Housing 2, in an area facing a combustion chamber in the installed state, has a thread 6, using which spark plug 1 may be screwed into a cylinder head housing (not shown in detail) of an internal combustion engine. Furthermore, a ground electrode 5 is provided at the combustion chamber-side end of housing 2, so that when an ignition voltage is applied between central electrode 4 and ground electrode 5, an ignition spark is formed for igniting a fuel mixture contained in the combustion chamber of an internal combustion engine.

In order to dissipate the heat transferred from the combustion chamber to insulator 3 to housing 2, a circumferential gap 7 having a predefined length is provided as heat transfer area 8 between housing 2 and insulator 3 in the area of the combustion chamber-side end of housing 2.

An additional element 9 is provided along this heat transfer area 8 for improving the heat transfer between insulator 3 and housing 2 in gap 7 surrounding the insulator, this element being designed as a ring in the embodiment of FIG. 1.

In order to clamp insulator 3 into housing 2 in the case of spark plug 1 according to the present invention, a so-called clamping area 14 is provided. Clamping area 14 is provided approximately in a central area of spark plug 1 according to the present invention in the area of an external polygon 15 of housing 2. External polygon 15 is used for screwing in spark plug 1 into a cylinder head housing not shown in detail, using a tool.

Clamping area 14 is axially delimited by a crimped border 18 of housing 2 and by a housing shoulder 19, the distance between crimped border 18 and housing shoulder 19 being referred to as the clamping length. A section of insulator 3 delimited by stop shoulders 16, 17, which is held in clamping area 14 by shrinking on housing 2, is associated with clamping area 14.

According to the present invention, heat transfer area 8 is spatially separated from clamping area 14, whereby a particularly slim shape of spark plug 1 may be implemented, in particular in the area of thread 6.

In the specific embodiment depicted in FIG. 1, housing shoulder 19 in the central area of spark plug 1 is used as a seal seat for sealing gap 7 on the combustion chamber side and is provided with a sealing ring 20. In this way, gap 7, connected to the combustion chamber, is sealed against the environment.

End 21 of spark plug 1 facing away from the combustion chamber has essentially a connecting means 22, connecting means 22 ensuring electrical contacting of central electrode 4 with an external voltage supply.

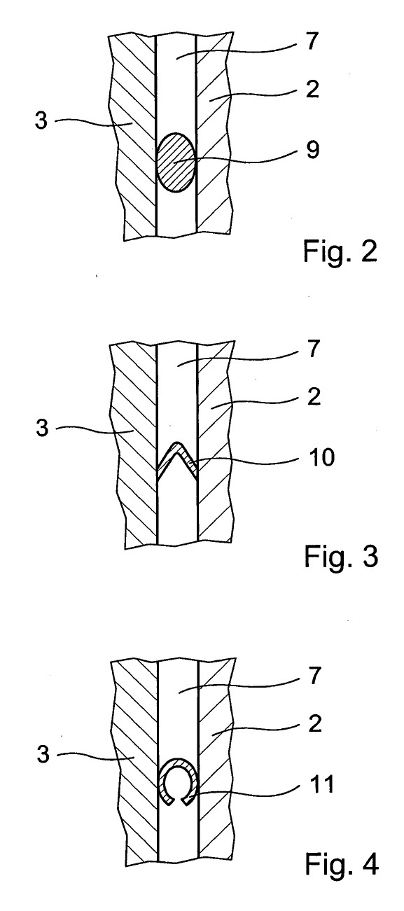

FIGS. 2 through 6 each depict an embodiment variant of area A from FIG. 1, i.e., the area of heat transfer area 8 representing the element for improving the heat transfer to housing 2, in gap 7 between insulator 3 and housing 2; the different specific embodiments may also be combined with each other.

FIG. 2, similarly to FIG. 1, depicts the element for improving the heat transfer which is designed as a toroidal ring 9, which is made of a heat-conducting material such as copper, for example.

In FIG. 3, the element for improving the heat transfer is designed as a rotation-symmetric spring element 10.

FIG. 4 shows another specific embodiment in which the element for improving the heat transfer is designed as a hollow section in the shape of an open hollow ring 11.

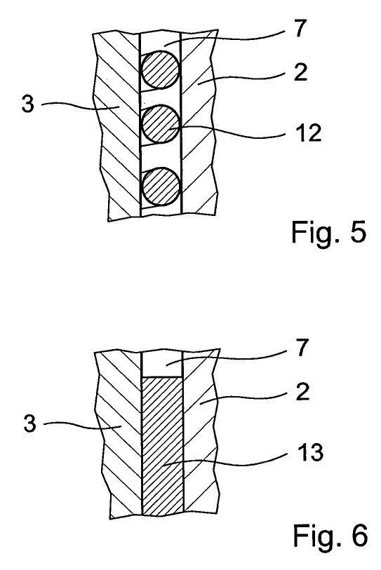

FIG. 5 shows another possible embodiment, in which the element for improving the heat transfer is designed as a coiled wire 12, i.e., a spiral.

Finally, FIG. 6 shows an embodiment in which the element for improving the heat transfer is designed as a sleeve 13. This sleeve is also preferably made of a heat-conducting material such as copper, for example.

1-12. (canceled)

13. A spark plug for an internal combustion engine comprising:
a housing;
a central electrode;
an insulator held in a clamping area of the housing, which electrically insulates the central electrode from the housing; and
a heat transfer area having a circumferential gap between the housing and the insulator, the heat transfer area being situated in an area of a combustion chamber-side end section of the housing for dissipating heat absorbed by the insulator,
wherein the heat transfer area and the clamping area are spatially separated from each other.

14. The spark plug according to claim 13, wherein the clamping area is situated between an axially central section and an end of the housing facing away from a combustion chamber.

15. The spark plug according to claim 13, wherein the clamping area is delimited axially on one side by a crimped border of the housing and, on the other side, by a housing shoulder.

16. The spark plug according to claim 13, wherein the clamping area surrounds a longitudinal section of the insulator delimited by support shoulders, the longitudinal section being situated substantially in a central area of the insulator.

17. The spark plug according to claim 16, wherein the insulator is held in the clamping area by shrinking on the housing.

18. The spark plug according to claim 15, wherein the housing shoulder includes a seal seat having a sealing ring for sealing a gap on a combustion chamber side.

19. The spark plug according to claim 13, further comprising at least one element for improving a heat transfer situated in a gap along the heat transfer area.

20. The spark plug according to claim 19, wherein the at least one element includes at least one spring element made of a heat-conducting material.

21. The spark plug according to claim 19, wherein the at least one element includes at least one ring element made of a heat-conducting material.

22. The spark plug according to claim 19, wherein the at least one element includes at least one hollow section made of a heat-conducting material.

23. The spark plug according to claim 19, wherein the at least one element includes a coiled wire made of a heat-conducting material.

24. The spark plug according to claim 19, wherein the at least one element includes at least one sleeve made of a heat-conducting material.
